(19) United States
(12) Patent Application Publication
(10) Pub. No.: US 2015/0123881 A1
(43) Pub. Date: May 7, 2015

(54) HEAD-MOUNTED DISPLAY DEVICE

(71) Applicant: OLYMPUS CORPORATION, Tokyo (JP)

(72) Inventors: Ryohei SUGIHARA, Tokyo (JP); Seiji TATSUTA, Tokyo (JP); Teruo TOMITA, Tokyo (JP); Tetsuyuki SAKAMOTO, Tokyo (JP)

(73) Assignee: OLYMPUS CORPORATION, Tokyo (JP)

(21) Appl. No.: 14/533,457

(22) Filed: Nov. 5, 2014

Related U.S. Application Data
(63) Continuation of application No. PCT/JP2013/063072, filed on May 9, 2013.

(30) Foreign Application Priority Data
May 14, 2012 (JP) 2012-110435

(51) Int. Cl. G02B 27/01

(52) U.S. Cl. CPC G02B 27/0176
USPC 345/8

(57) ABSTRACT

A head-mounted display device including: a holder which is mounted on the head of a user; and a display unit which is supported by the holder and has a display element, wherein the holder includes: a first casing which includes an electronic circuit board having at least a drive circuit for generating a drive signal for driving the display element of the display unit; a second casing on which the display unit is fixed; and a flexible support part having flexibility which has a wire for electrically connecting the drive circuit and the display element and which connects the first casing and the second casing.

### CROSS-REFERENCE TO RELATED APPLICATIONS

This application is a Continuation Application of International Application PCT/JP2013/063072 filed on May 9, 2013, which claims priority to Japanese Application No. 2012-110435 filed on May 14, 2012.

The Contents of International Application PCT/JP2013/063072 and Japanese application No. 2012-110435 are hereby incorporated by reference herein in its entirety.

### TECHNICAL FIELD

The present invention relates to a head-mounted display device.

### BACKGROUND ART

In a head-mounted display device, there is a conventionally known technique of supporting a display unit, which forms an image, on a head-mountable holder through a tube-like flexible member (e.g., see PTL 1).

In this head-mounted display device, image display light is emitted in a display unit by means of a drive signal which is transmitted through a cable from an external image source such as a computer. The cable is connected with the display unit, through the holder and the flexible member, at the end on the side of the head-mounted display device.

### CITATION LIST

### Patent Literature {PTL 1}

Japanese Unexamined Patent Application, Publication No. 2000-224519

### SUMMARY OF INVENTION

According to one aspect of the present invention, there is provided a head-mounted display device including: a holder which is mounted on the head of a user; and a display unit which is supported by the holder and has a display element, wherein the holder includes: a first casing which includes an electronic circuit board having at least a drive circuit for generating a drive signal for driving the display element of the display unit; a second casing on which the display unit is fixed; and a flexible support part having flexibility which has a wire for electrically connecting the drive circuit and the display element and which connects the first casing and the second casing.

### BRIEF DESCRIPTION OF DRAWINGS

FIG. 1(a) is a plan view showing the outline of a head-mounted display device according to a first embodiment of the present invention.

FIG. 1(b) is a side view showing the outline of the head-mounted display device according to the first embodiment of the present invention.

FIG. 2 is a block diagram showing the configuration of the component layout of the head-mounted display device according to the first embodiment of the present invention.

FIG. 3(a) is a plan view showing the internal configuration of the head-mounted display device according to the first embodiment of the present invention.

FIG. 3(b) is a side view showing the internal configuration of the head-mounted display device according to the first embodiment of the present invention.

FIG. 4 is a view showing a modified example of a flexible support part of the head-mounted display device according to the first embodiment of the present invention.

FIG. 5 is a view showing the configuration of a flexible support part according to a second embodiment of the present invention.

FIG. 6 is a view showing the configuration of a modified example of the flexible support part according to the second embodiment of the present invention.

FIG. 7(a) is an outline view showing the configuration of a flexible support part according to a third embodiment of the present invention.

FIG. 7(b) is a cross-sectional view showing the configuration of the flexible support part according to the third embodiment of the present invention.

FIG. 8 is a view showing the configuration of a modified example of the flexible support part according to the third embodiment of the present invention.

FIG. 9(a) is a view showing the configuration of a flexible support part according to a fourth embodiment of the present invention.

FIG. 9(b) is an enlarged view of a part of FIG. 9(a).

FIG. 10 is a view showing the configuration of a modified example of the flexible support part according to the fourth embodiment of the present invention.

FIG. 11(a) is a side view showing a modified example of a core wire which is used in the fourth embodiment of the present invention.

FIG. 11(b) is a cross-sectional view of the core wire of FIG. 11(a).

### DESCRIPTION OF EMBODIMENTS

In the following, a head-mounted display device according to embodiments of the present invention will be described with reference to the drawings.

### First Embodiment

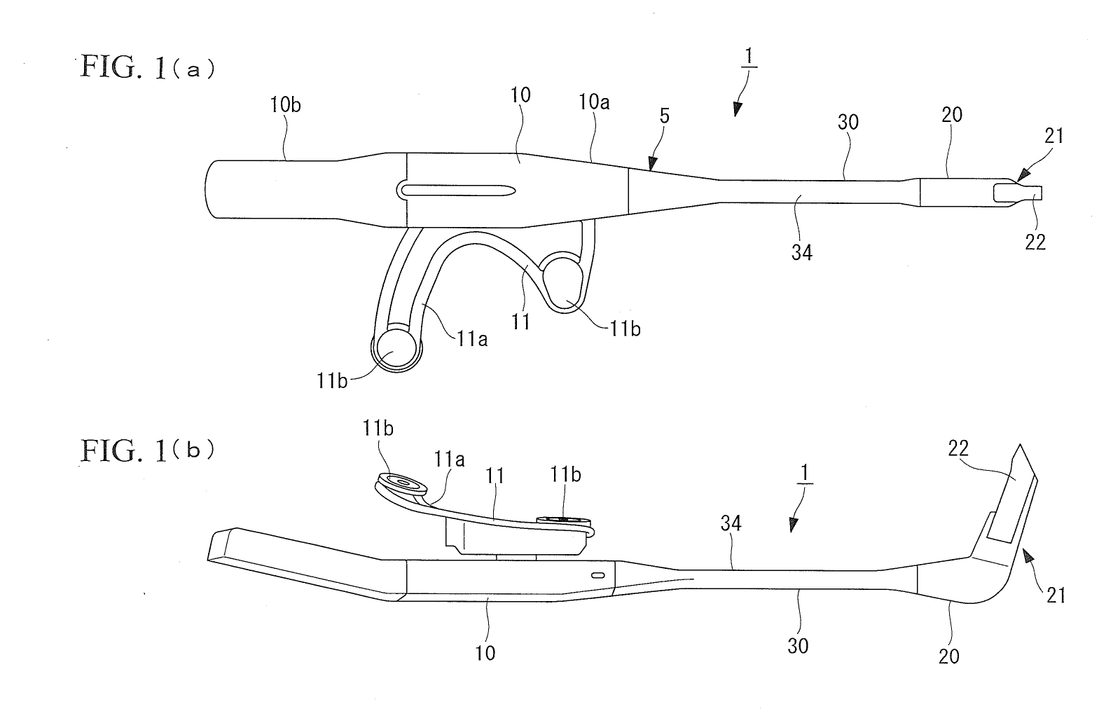

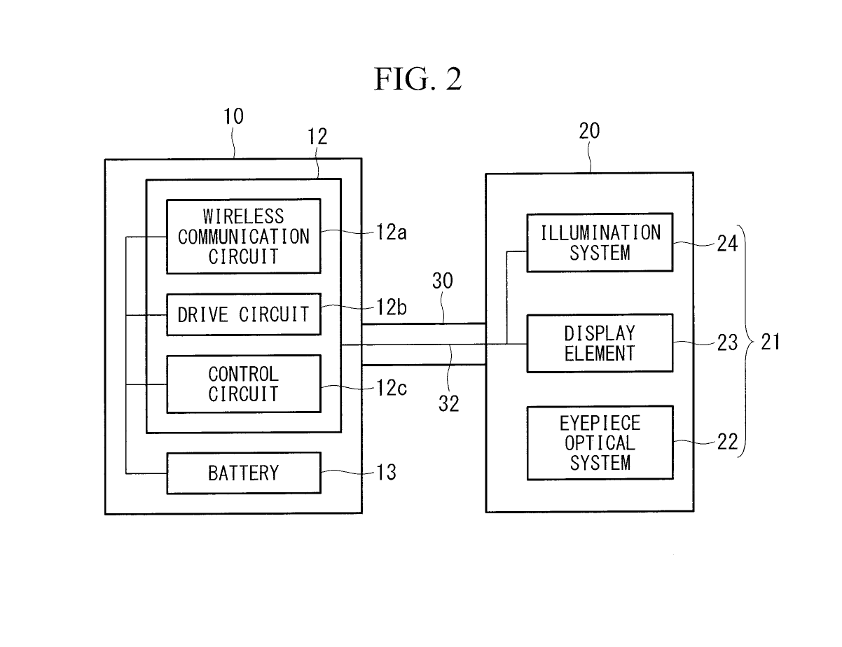

A head-mounted display device according to a first embodiment of the present invention will now be described using FIGS. 1(a), 1(b), and FIG. 2.

FIG. 1(a) and FIG. 1(b) are a plan view and a side view, respectively, showing the outline of a head-mounted display device 1. FIG. 2 is a block diagram showing the configuration of the component layout of the head-mounted display device 1.

As shown in FIGS. 1(a), 1(b), and FIG. 2, the head-mounted display device 1 has: a display unit 21; and a holder 5 which supports the display unit 21 and is mounted on the head of a user.

The holder 5 has: a first casing 10 which has a head support member 11 for engaging the head-mounted display device on the head (e.g., the ear) of the user; a second casing 20 on which the display unit 21 is fixed; and a flexible support part 30 which connects the first casing 10 and the second casing 20.

The first casing 10 has: a tapered portion 10a which gradually increases in cross-sectional area from the end on the flexible support part 30 side toward the end on the opposite side; and a cylindrical portion 10b which continues to the tapered portion 10a and has almost a constant cross-sectional area. The cylindrical portion 10b is formed so as to be bent, relative to the central axis of the tapered portion 10a, toward the side which is closer to the head of the user when the user wears the head-mounted display device 1. However, the shape of the first casing 10 is not limited to this example.

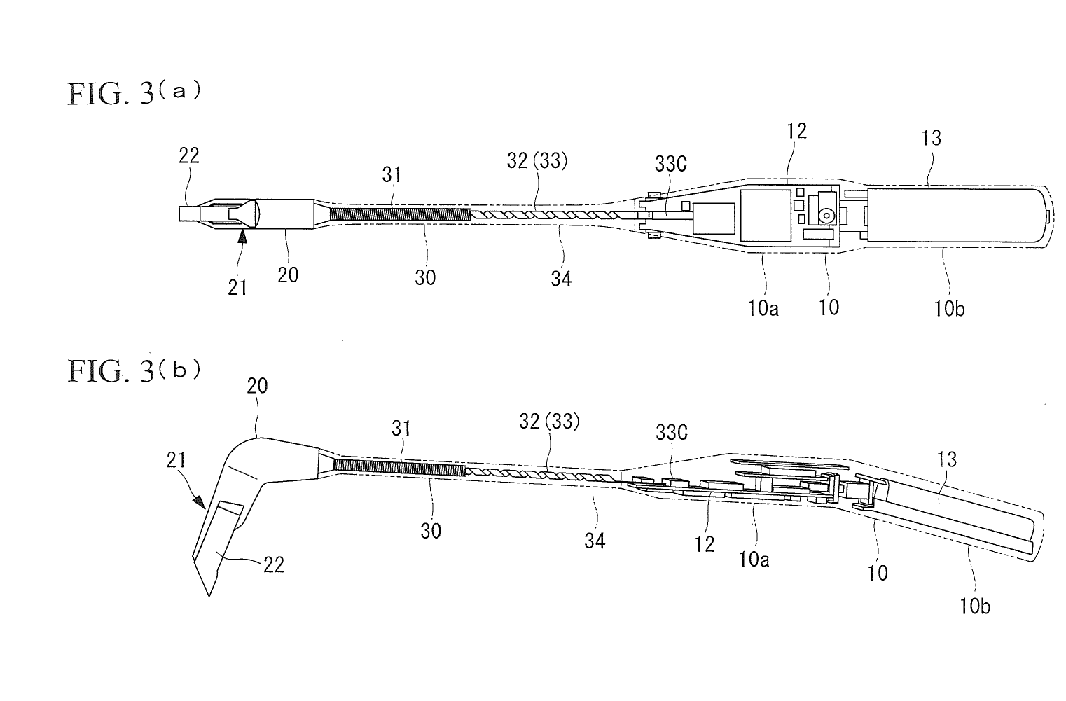

As shown in FIG. 2 and FIGS. 3(a) and 3(b), the first casing 10 houses: an electronic circuit board 12 which includes a wireless communication circuit 12a which receives a signal transmitted from the outside through wireless communication such as Bluetooth or Wi-Fi, a drive circuit 12b which generates and outputs a signal for driving the display unit 21, a control circuit 12c, and the like; and a battery 13 for supplying power to the electronic circuit board 12.

In this embodiment, the electronic circuit board 12 is embedded in the tapered portion 10a, and the battery 13 is housed in the cylindrical portion 10b.

As shown in FIGS. 1(a) and 1(b), the head support member 11 includes a hook 11a which can be engaged, for example, on the ear of the user and pads 11b on the outer circumferential surface of the tapered portion 10a of the first casing 10. However, the shape and the configuration of the head support member 11 are by no means limited to these examples.

The cross-sectional area of the second casing 20 gradually increases from the end on the flexible support part 30 side, and the other end on the opposite side is provided with an eyepiece optical system 22 which constitutes the display unit 21.

As shown in FIG. 2, a display element 23 such as an LCD and an illumination system 24 constituting the display unit 21 are embedded in the second casing 20.

In the display unit 21, the display element 23 is driven by the drive signal transmitted from the drive circuit 12b, and displays a video according to the drive signal. The illumination system 24 illuminates the display element 23 and guides the video displayed on the display element 23 to the eyepiece optical system 22. In the eyepiece optical system 22, the light of the guided video is guided to the pupil of the user.

As shown in FIGS. 1(a), 1(b) and FIGS. 3(a), 3(b), the flexible support part 30 has a rod-like shape with an almost constant outer diameter from the first casing 10 side toward the second casing 20 side, and has flexibility. This allows the user to appropriately adjust the position or the direction of the second casing 20 relative to the first casing 10 by bending the flexible support part 30. More specifically, the user adjusts the position or the direction of the second casing 20 for the purposes such as: positioning the optical axis of the eyepiece optical system 22 to the pupil of the user; changing the position of the display screen in the sight of the user by changing the angle of the optical axis of the eyepiece optical system 22 relative to the pupil of the user; and, when the head-mounted display device is not used, removing the eyepiece optical system 22 to a position where it does not obstruct the sight of the user.

The flexible support part 30 can be attached to and detached from the first casing 10 at the end on the first casing 10 side.

As shown in FIGS. 3(a) and 3(b), the flexible support part 30 has, for example: a hollow flexible tube 31; a wire 32 which is inserted through the flexible tube 31 and electrically connects the electronic circuit board 12 inside the first casing 10 and the display element 23 (not shown) inside the second casing 20; and a sleeve 34 which is made of a resin material, a rubber material, or the like, and covers the flexible tube 31.

The flexible tube 31 has a shape of a coil spring formed of a metal wire material being wound spirally, and has the flexibility for allowing the user to freely bend the flexible tube 31 by hand and the shape retaining property for retaining the shape as is when the user lets go of the flexible tube 31. This flexible tube 31 is covered with the sleeve 34 by insert molding.

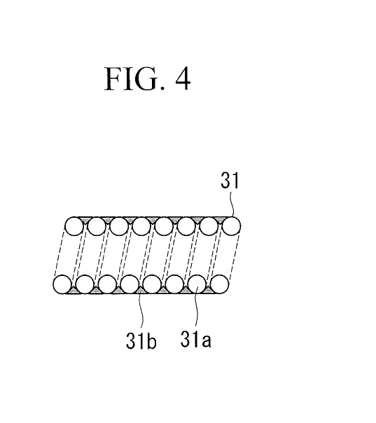

In another possible configuration, the flexible tube 31 as shown in FIG. 4 may have a shape of a coil spring formed of a metal wire material 31a with a circular cross-section being wound spirally, and a metal wire material 31b with a triangular (wedge-shaped) cross-section may be wound between the wire materials 31a and 31a adjacent to each other on the outer circumferential surface side of the flexible tube 31.

This flexible tube 31 preferably has an inner diameter of 2.5 mm or larger and an outer diameter of 4.5 mm or smaller.

As shown in FIGS. 3(a) and 3(b), for example, a flexible printed wire 33 wound spirally may be used as the wire 32. In this case, the flexible printed wire 33 constituting the wire 32 has the end on the second casing 20 side connected with the display element 23 by crimping, etc., and a connector 33C is mounted on the other end of the flexible printed wire 33 on the opposite side, namely, the first casing 10 side. The flexible printed wire 33 is electrically connected with the electronic circuit board 12 by the connector 33C being fitted into a receiving-side connector mounted on the electronic circuit board 12.

Here, during assembly, the flexible printed wire 33 having one end connected with the display element 23 of the display unit 21 is passed through the flexible tube 31 from one end side thereof so as to protrude at the other end, and this connector 33C is fitted into the receiving-side connector on the electronic circuit board 12. For this purpose, it is preferable that the width dimension of the connector 33C in the direction perpendicular to the longitudinal direction of the flexible printed wire 33 is smaller than the inner diameter of the flexible tube 31.

In such a head-mounted display device 1, a video (including an image) signal, which is wirelessly transmitted from an external video reproducing device, etc. using, for example, a personal computer, a television, an HDD (Hard Disk Drive), or a DVD (Digital Versatile Disc), is received in the wireless communication circuit 12a of the electronic circuit board 12 provided inside the first casing 10.

The video signal received in the wireless communication circuit 12a is converted into a drive signal for driving the display element 23 of the display unit 21 in the drive circuit 12b. The drive signal thus generated in the drive circuit 12b is transmitted to the display unit 21 of the second casing 20 through the flexible printed wire 33.

In the display unit 21, the display element 23 is driven by the transmitted drive signal, and the display element 23 displays a video according to the drive signal. The video displayed in the display element 23 is guided to the eyepiece optical system 22 by the light emitted from the illumination system 24, and in the eyepiece optical system 22, the light of the guided video is guided to the pupil of the user.

According to the above-described head-mounted display device 1, the second casing 20 including the display unit 21 is connected with the first casing 10 through the flexible support part 30 having flexibility, and the drive circuit 12b for generating the drive signal for driving the display element 23 of the display unit 21 and the control circuit 12c are embedded in the first casing 10.

In this way, it is possible to keep down the weight of the second casing 20 by embedding the drive circuit 12b and the control circuit 12c in the first casing 10. Thus, since the flexible tube 31 of the flexible support part 30 is required to support only a small weight, the flexibility of the flexible tube 31 can be increased. As a result, the user can adjust the position or the orientation of the second casing 20 with a small force, and the ease of use of the head-mounted display device 1 can be enhanced.

Moreover, the head support member 11 is provided in the tapered portion 10a of the first casing 10, while the heavy-weight battery 13 is provided in the cylindrical portion 10b of the first casing 10 positioned on the side opposite to the second casing 20 across the head support member 11. In this way, a good weight balance is achieved between the display unit 21 and the battery 13, which contributes to the excellent feel of use when the user wears the head-mounted display device 1.

The drive signal of the display element 23 is not transmitted from the outside of the head-mounted display device 1; instead, the drive signal is generated in the drive circuit 12b inside the first casing 10 and transmitted to the display unit 21 of the second casing 20 through the flexible printed wire 33, requiring only a very short transmission distance. In this way, noise is less likely to ride on the drive signal, so that deterioration in the quality of the drive signal can be suppressed and a high-quality video can be displayed in the display unit 21.

While one example of the configuration of the flexible support part 30 has been shown in the above-described first embodiment, configurations as shown in the following examples are also possible other than the above-described example. In the following description, the overall configuration of the head-mounted display device 1 is the same as in the first embodiment, with the only difference being the configuration of the flexible support part 30. Therefore, components that are common with the above-described first embodiment will be denoted by the same reference signs and the description thereof will be omitted.

### Second Embodiment

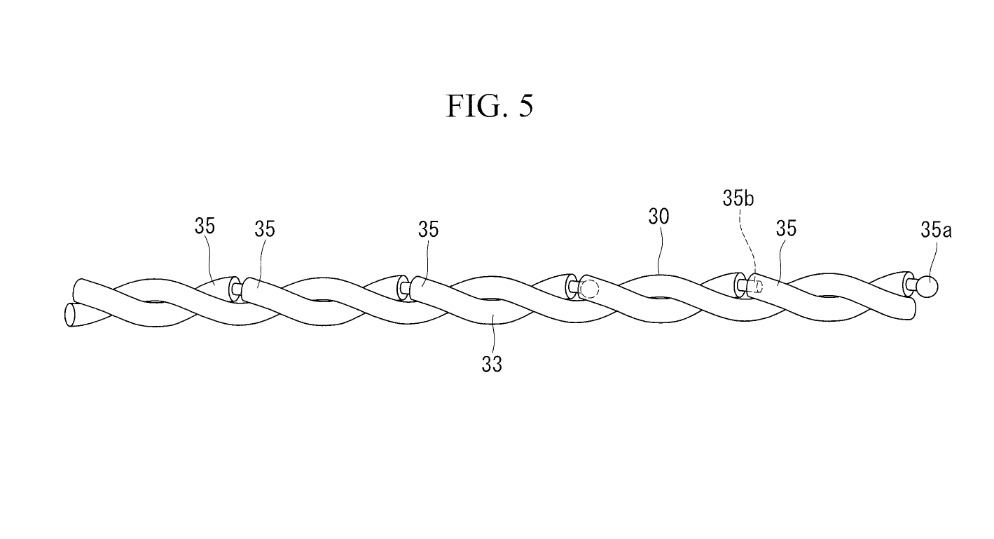

As shown in FIG. 5, the flexible support part 30 in this embodiment has a configuration in which multiple joint pieces 35 are joined and the flexible printed wire 33 is spirally wound around these joint pieces 35.

Here, each of the joint pieces 35 is spirally curved from one end toward the other end, and has a protrusion 35a on one side and a recess (not shown), into which the protrusion 35a is fitted, on the other end 35b. Two joint pieces 35 which are arranged one after the other in the longitudinal direction of the flexible support part 30 constitute a so-called ball joint with the protrusion 35a of one of the joint pieces 35 fitted into the recess at the other end 35b of the other joint piece 35, and these joint pieces are connected so as to be freely bendable around the protrusion 35a.

When a predetermined number of these joint pieces 35 are connected, the flexible support part 30 is formed which continues spirally as a whole and has the flexibility for allowing the user to freely bend it by hand and the shape retaining property for retaining the shape as is when the user lets go of it.

Here, it is also effective to make the fitting between the protrusion 35a and the recess at the joining part between adjacent ones of the multiple joint pieces 35, 35, and so on gradually looser toward the second casing 20 side such that the joint pieces can be bent with a smaller torque. In this way, when the flexible support part 30 is bent, the flexible support part 30 is likely to be subjected to larger deformation on the second casing 20 side.

The flexible printed wire 33 is wound spirally by being twisted with the joint pieces 35, 35, and so on which continue spirally.

Such joint pieces 35, 35, and so on and the flexible printed wire 33 are covered with the sleeve 34 (see FIGS. 1(a) and 1(b)) by insert molding and constitute the flexible support part 30.

According to the flexible support part 30 of such a configuration, since many joint pieces 35 of the same shape are used, reduction in the manufacturing cost can be achieved.

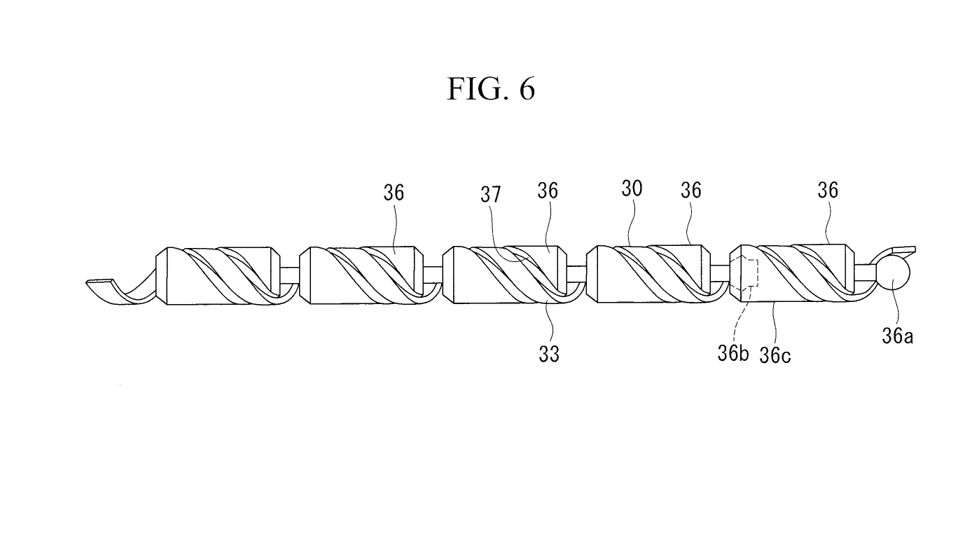

In the above-described embodiment, the shape of the joint piece 35 may be other than the above example. For example, a joint piece 36 shown in FIG. 6 has a spherical protrusion 36a on one end of its columnar main body 36c, and has a recess 36b, into which the protrusion 36a is fitted, on the other end. A spiral groove 37 is formed in the outer circumferential surface of the main body 36c, and the flexible printed wire 33 is held inside the spiral groove 37 and wound spirally.

### Third Embodiment

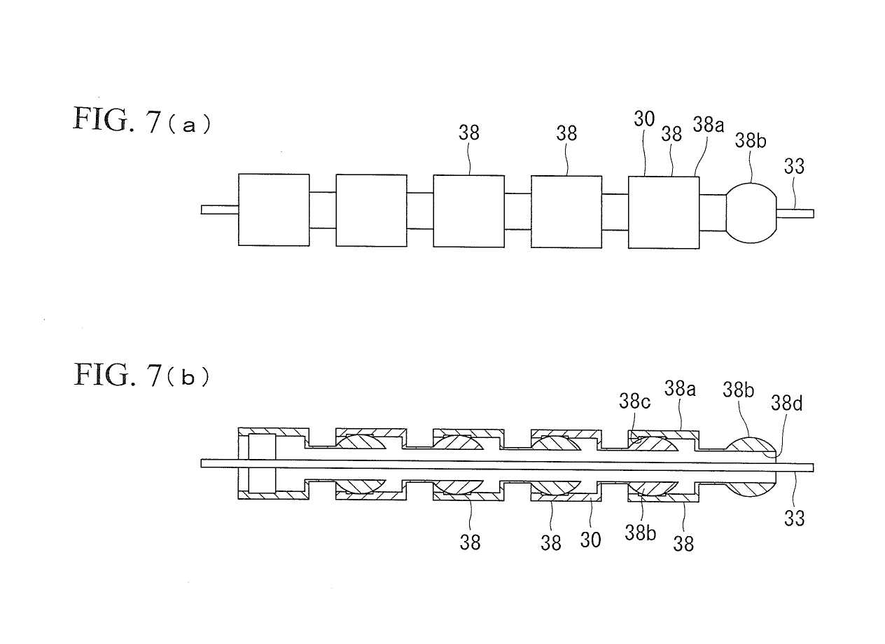

As shown in FIGS. 7(a) and 7(b), the flexible support part 30 in this embodiment has a configuration in which multiple joint pieces 38 are joined and the flexible printed wire 33 is inserted through the inside of these joint pieces 38.

Each of the joint pieces 38 has: a cylindrical main body 38a; a spherical protrusion 38b formed at one end of the main body 38a; and a recess 38c formed at the other end of the main body 38a, and a hole 38d which penetrates the main body 38a and the protrusion 38b is further formed in the joint piece 38.

Two joint pieces 38 arranged one after the other in the longitudinal direction of the flexible support part 30 constitute a so-called ball joint with the protrusion 38b of one of the joint pieces 38 fitted into the recess 38c of the other joint piece 38, and these joint pieces are connected so as to be freely bendable around the protrusion 38b.

When a predetermined number of these joint pieces 38 are joined, the flexible support part 30 is formed which has the flexibility for allowing the user to freely bend it by hand and the shape retaining property for retaining the shape as is when the user lets go of it.

The flexible printed wire 33 is inserted through the holes 38d of these joint pieces 38.

Such joint pieces 38, 38, and so on are covered with the sleeve 34 (see FIGS. 1(a) and 1(b)) by insert molding and constitute the flexible support part 30.

Also with the flexible support part 30 of such a configuration, since many joint pieces 38 of the same shape are used, reduction in the manufacturing cost can be achieved. In addition, since the flexible printed wire 33 is inserted through the joint pieces 38, breakage, etc. of the flexible printed wire 33 can be prevented.

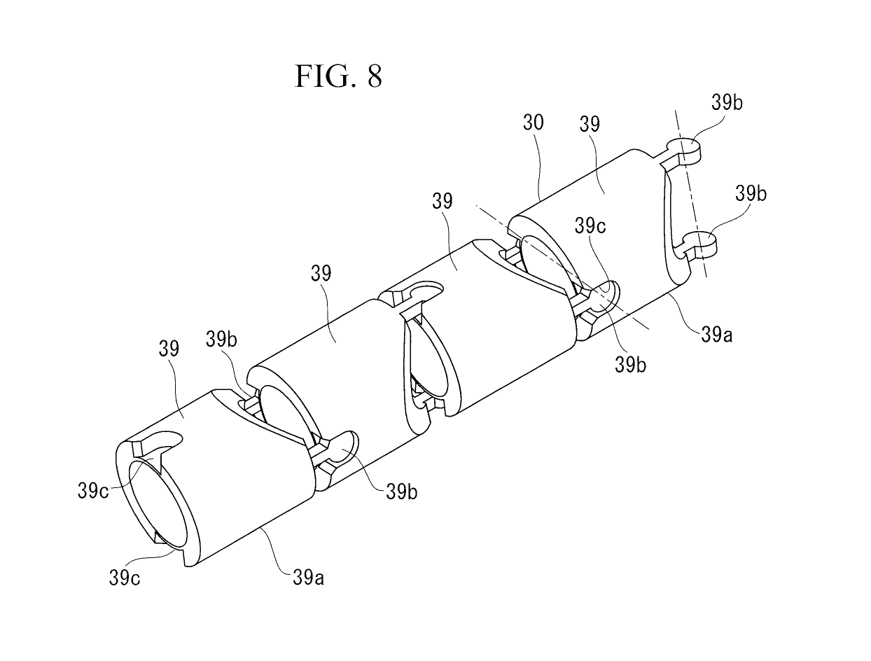

In the above-described third embodiment, a joint piece 39 as shown in FIG. 8 can also be used instead of the joint piece 38.

In this joint piece 39, a pair of protrusions 39b and 39b located across the center of a cylindrical main body 39a is formed at one end of the main body 39a, while a pair of recesses 39c and 39c located across the center of the main body 39a is formed at the other end of the main body 39a.

The protrusion 39b is formed so as to protrude along the axial direction of the main body 39a from the outer circumferential surface of the cylindrical main body 39a, while the recess 39c is formed in the main body 39a itself. In each of the joint pieces 39, the protrusions 39b and 39b and the recesses 39c and 39c are formed so as to be different in phase by 90° around the center of the main body 39a.

Two joint pieces 39 and 39 arranged one after the other in the longitudinal direction of the flexible support part 30 have the protrusions 39b and 39b of one of the joint pieces 39 fitted into the recesses 39c and 39c of the other joint piece 39. In this way, one joint piece 39 and the other joint piece 39 are rotatably joined with the axis extending in the direction which connects the protrusions 39b and 39b of one joint piece 39. Then, since the protrusions 39b and 39b on one end and the recesses 39c and 39c at the other end are different in phase by 90° around the central axis of the main body 39a in each of the joint pieces 38, one joint piece 38 is joined with other joint pieces 38 so as to be rotatable around the axes at one end and the other end of the one joint piece 38 which are at 90° to each other.

### Fourth Embodiment

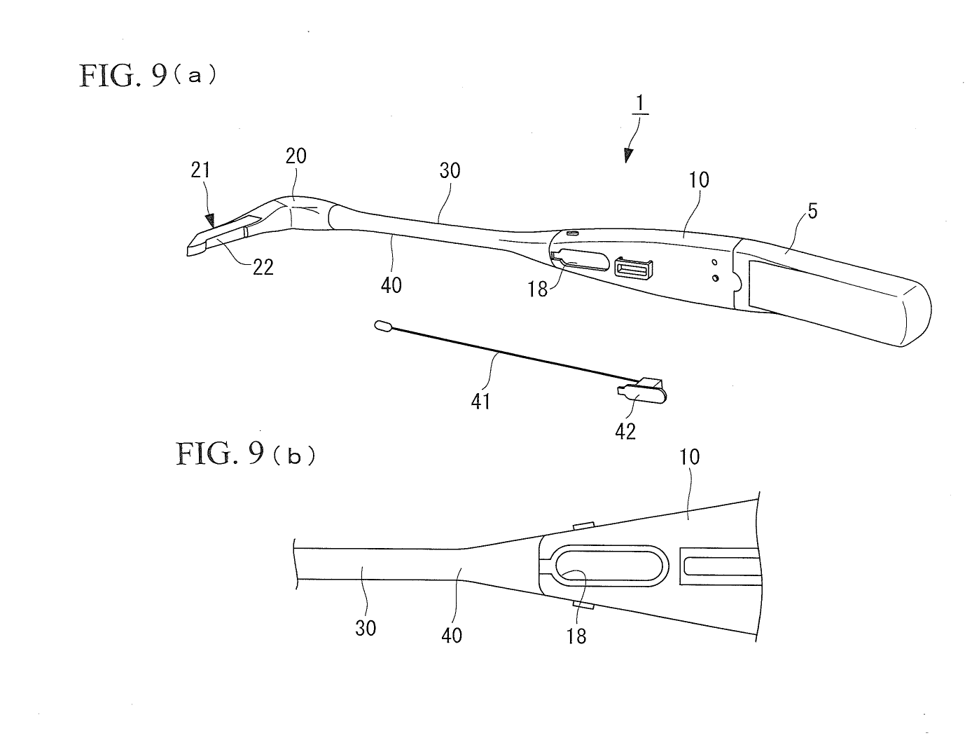

As shown in FIGS. 9(a) and 9(b), the flexible support part 30 in this embodiment has: a cylindrical sleeve 40 which is made of a resin material or a rubber material and has flexibility; the flexible printed wire 33 (not shown) inserted through the sleeve 40; and a core wire 41 inserted through the sleeve 40.

The core wire 41 is made of a metal wire material, etc. and is inserted through the flexible sleeve 40 to thereby allow the flexible support part 30 to be deformed and retained in the deformed shape. Such a core wire 41 preferably has a diameter of approximately 0.5 to 1.2 mm.

In this case, it is also possible to make the core wire 41 replaceable by forming an opening 18 in the first casing 10, inserting the core wire through this opening 18 into the sleeve 40, and fitting a fixing part 42 provided at one end of the core wire 41 into the opening 18. In this way, when the core wire 41 has deteriorated, it can be appropriately replaced.

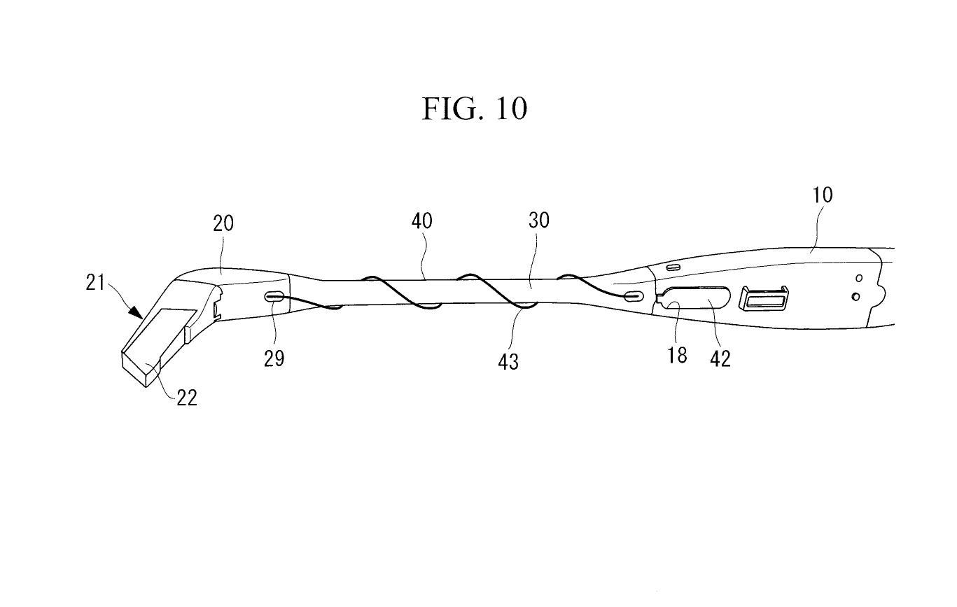

In the above-described embodiment, instead of the core wire 41 being inserted through the sleeve 40, the core wire 43 may be wound spirally along the outer circumferential surface of the sleeve 40 as shown in FIGS. 10.

In this case, it is preferable that the first casing 10 and the second casing 20 are formed with the openings 18 and 29, respectively, for fixing both ends of the core wire 43.

In this configuration, since the core wire 43 is exposed on the outer circumferential surface side of the sleeve 40, the replacement work can be easily performed.

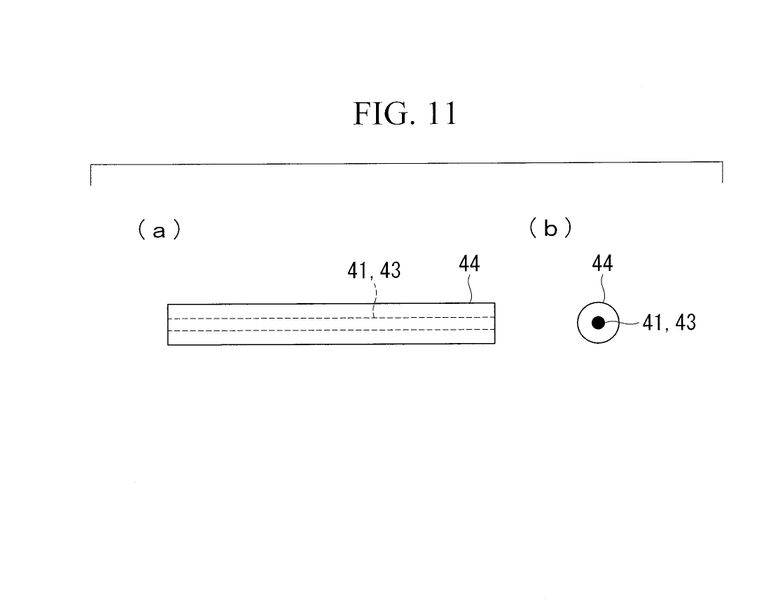

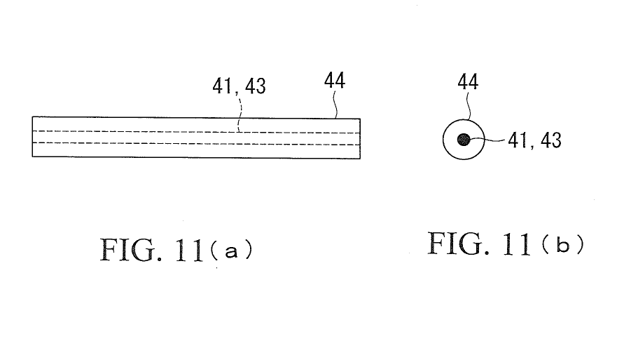

The core wires 41 and 43 as described above may be such that the core wires 41 and 43 made of a metal material are coated with a coating layer 44 of a resin material as shown in FIGS. 11(a) and 11(b).

When the flexible printed wire 33 or the core wire 43 is wound around the outer circumferential surface of the flexible tube 31 or the sleeve 40, the flexible tube 31, the sleeve 40, the flexible printed wire 33, and the core wire 43 may be covered with a resin film.

In this case, the flexible printed wire 33 and the core wire 43 may be covered with a film by insert molding on the outer circumferential surfaces of the flexible tube 31 and the sleeve 40.

Other than the configurations shown in the above-described embodiments, appropriate changes and addition or omission of the configurations can be made within the scope of the present invention.

In addition, it is also possible to appropriately combine the configurations shown in the above-described embodiments.

On the basis of the embodiment described above, inventions as follows are derived.

According to one aspect of the present invention, there is provided a head-mounted display device including: a holder which is mounted on the head of a user; and a display unit which is supported by the holder and has a display element, wherein the holder includes: a first casing which includes an electronic circuit board having at least a drive circuit for generating a drive signal for driving the display element of the display unit; a second casing on which the display unit is fixed; and a flexible support part having flexibility which has a wire for electrically connecting the drive circuit and the display element and which connects the first casing and the second casing.

In such a head-mounted display device, reduction in weight of the second casing having the display unit can be achieved since the electronic circuit board having at least the drive circuit is provided in the first casing.

Moreover, since the drive circuit of the first casing and the display element of the second casing are electrically connected through the wire of the flexible support part, a shorter wire can be used and the noise riding on the drive signal can be suppressed compared with the case where the drive signal is sent from the outside.

In the above-described aspect, it is preferable that the holder is mounted on the head of the user through the first casing. To support the holder on the head of the user through the first casing, the holder may be directly engaged on the ear, etc. of the user, or the holder may be engaged on the head of the user by means of a head support member provided in the first casing.

In the above-described aspect, the first casing may include a battery for supplying power to the drive circuit, and the battery may be disposed on the side opposite to the second casing across a support position in the first casing at which the head-mounted display device is mounted on the head of the user.

In this way, a good balance is achieved when the holder is mounted on the head of the user.

In the above-described aspect, the display unit may have: the display element; an illumination optical system for illuminating a video displayed by the display element; and an eyepiece optical system for emitting the video illuminated by the illumination optical system toward the eyeball of the user.

In addition, in the above-described aspect, as long as the first casing is provided with the drive circuit and the second casing includes the display element, the present invention can also be applied to other display units, for example, to those without the eyepiece optical system and the illumination optical system.

In the above-described aspect, the flexible support part may be cylindrical and the wire may be inserted through the inside of the flexible support part.

In this aspect, the wire may have a connector, which is connected with the drive circuit, at the end on the first casing side, and the dimension of the connector in the direction perpendicular to the direction in which the wire continues may be set to be smaller than the inner diameter of the cylindrical flexible support part.

In addition, in the above-described aspect, the cylindrical flexible support part may be made of metal and have an inner diameter of 2.5 mm or larger and an outer diameter of 5 mm or smaller.

In the above-described aspect, the wire may be wound around the outer circumferential surface of the flexible support part.

### Advantageous Effects of Invention

The present invention offers advantages in that reduction in weight of the second casing having the display unit can be achieved, and that the excellent ease of use during positional adjustment can be secured without impairing the flexibility of the flexible member.

In addition, the present invention offers another advantage in that the noise riding on the drive signal which is generated in the drive circuit and transmitted to the display element can be suppressed, so that the image display quality can be enhanced.

### REFERENCE SIGNS LIST

1 Head-mounted display device
5 Holder
10 First casing
10a Tapered portion
10b Cylindrical portion
11 Head support member
12 Electronic circuit board
12a Wireless communication circuit
12b Drive circuit
12c Control circuit
13 Battery
20 Second casing
21 Display unit
22 Eyepiece optical system
23 Display element
24 Illumination system
30 Flexible support part
31 Flexible tube
31a Wire material
31b Wire material
32 Wire
33 Flexible printed wire
33C Connector
34 Sleeve
35, 36, 38, 39 Joint piece
37 Groove
40 Sleeve
41, 43 Core wire
42 Fixing part
44 Coating layer

1. A head-mounted display device comprising:
a holder which is mounted on the head of a user; and
a display unit which is supported by the holder and has a display element, wherein
the holder comprises: a first casing which includes an electronic circuit board having at least a drive circuit for generating a drive signal for driving the display element of the display unit; a second casing on which the display unit is fixed; and a flexible support part having flexibility which has a wire for electrically connecting the drive circuit and the display element and which connects the first casing and the second casing.

2. The head-mounted display device according to claim 1, wherein the holder is mounted on the head of the user through the first casing.

3. The head-mounted display device according to claim 2, wherein
the first casing includes a battery for supplying power to the drive circuit, and
the battery is disposed on the side opposite to the second casing across a support position in the first casing at which the head-mounted display device is mounted on the head of the user.

4. The head-mounted display device according to claim 1, wherein
the display unit has: the display element; an illumination optical system for illuminating an image displayed on the display element; and an eyepiece optical system that allows the user to observe an image displayed on the display element as a virtual image

5. The head-mounted display device according to claim 1, wherein
the flexible support part is cylindrical, and
the wire is inserted through the inside of the flexible support part.

6. The head-mounted display device according to claim 5, wherein
the wire has a connector, which is connected with the drive circuit, at the end on the first casing side, and
the dimension of the connector in the direction perpendicular to the direction of the wire is set to be smaller than the inner diameter of the cylindrical flexible support part.

7. The head-mounted display device according to claim 5, wherein the cylindrical flexible support part is made of metal and has an inner diameter of 2.5 mm or larger and an outer diameter of 5 mm or smaller.

8. The head-mounted display device according to claim 1, wherein the wire is wound around the outer circumferential surface of the flexible support part.
